(19) United States
(12) Patent Application Publication
(10) Pub. No.: US 2015/0194756 A1
(43) Pub. Date: Jul. 9, 2015

(54) STRESS-MINIMISING ELECTRICAL THROUGH-CONTACT

(71) Applicant: Robert Bosch GmbH, Stuttgart (DE)

(72) Inventors: Friedhelm Guenter, Burgstetten (DE); Reiner Ramsayer, Rutesheim (DE); Andreas Fix, Stuttgart (DE); Michael Guyenot, Ludwigsburg (DE); Roumen Ratchev, Stuttgart (DE)

(73) Assignee: Robert Bosch GmbH, Stuttgart (DE)

(21) Appl. No.: 14/419,415

(22) PCT Filed: Jul. 24, 2013
(86) PCT No.: PCT/EP2013/065589

§ 371 Date: Feb. 3, 2015

(30) Foreign Application Priority Data
Aug. 3, 2012 (DE) 10 2012 213 804.8

(51) Int. Cl. H01R 13/03; H01R 43/16

(52) U.S. Cl. CPC H01R 13/03; H01R 43/16

(57) ABSTRACT

The invention relates to a contact element (10) with a plug side (14) and a solder side (16) to be contacted with a circuit board or a carrier substrate. The contact element (10) is produced from an Al/Cu material composite (36), the Cu portion (42) of which forms the plug side (14) and the Al portion (44) of which forms the solder side (16) of the contact element (10).

### BACKGROUND OF THE INVENTION

The German patent application DE 10 2004 030 388 A1 relates to an article with a coating of electrically conductive polymer and a method for the production thereof. According to this solution, circuit boards are provided with a copper layer in which electrical conductors are produced by means of structuring. A layer of electrically conductive polymer is applied to the copper layer in order to maintain the solderability thereof and to protect the same from oxidation. The copper or copper alloy layer is located between an electrically conductive basis layer and a layer containing the conductive polymer.

The German patent application DE 10 2009 001 461 A1 relates to a method for producing an electronic assembly. The assembly is formed by two microelectronic components which are connected to one another. The connection is established by means of a plurality of dielectric components which comprise respectively at least one conductor track. The conductor track is produced by introducing a continuous cavity into the dielectric component and by subsequently filling said cavity with an electrically conductive material. The filling material can relate to an electrically conductive polymer.

A THT manufacturing process (through-hole technology) is used for the purpose of electrical contacting. According to this manufacturing process, the connecting wires of wired components as well as male multipoint connecters are inserted through openings in the circuit board. The components to be contacted can relate to capacitors, transistors, resistors, integrated circuits (ICs) and the like. The listed components require different preparations in which the connecting wires, which are also denoted as connecting pins, are bent and cut so that said connecting wires fit into a bore pattern or opening pattern predefined by the circuit board. After preparing the components and equipping the circuit board with the same, said components are soldered. The soldered connection occurs as a rule on the bottom side of the circuit board. To this end, the wave soldering method or the flow soldering method can be used. In the case of wave soldering, the circuit board is passed with the bottom side thereof over a solder wave which, when making contact with the bottom side of the component, produces the soldered connection. A special way of carrying out said method is known as selective soldering. In this case, the entire assembly is not soldered but only a small portion thereof—partially only a single component—by means of a miniature wave. The selective soldering method is frequently the only possible soldering method if wired components have to be soldered.

In particular in applications in the automotive field, the soldered joints produced by means of the THT manufacturing method have to be able to withstand a large number of temperature changes without the function of the soldered joint being significantly affected on the one hand with regard to the electrical conductivity thereof and on the other hand with regard to the mechanical stability thereof. Thermomechanically induced stresses occur however in the soldered joints due to the temperature changes, which stresses can lead to damage to the soldered joints. Said stresses are determined by geometrical factors with respect to all components and furthermore are dependent on transient thermal conditions (temperature/time profiles).

As a result of the development trend towards intramodular design of control devices, individual modules and not only individual components are connected by THT soldering technology to the actual circuit board. In particular for applications in the automotive sector, THT soldered joints have to withstand many temperature changes without the function of the soldered joint being significantly compromised with regard to the conductivity thereof and to the mechanical stability thereof. Due to the temperature changes, thermomechanically induced stresses result in the soldered joints, which can lead to premature damage to the soldered joints. The stresses are determined by geometrical factors of all components and are dependent on transient thermal stresses. A majority of components that are soldered by means of applications of the THT method relates to connector strips that are soldered on one side and are preferably used in electronic control devices. Contact pins being used, which are also denoted simply as pins, are manufactured from bronze and for the most part punched out of bands. In so doing, it is however absolutely necessary for the material on the plug side to correspond to the material classes of the automobile manufacturer required to date. In contrast, the materials on the solder side can be freely defined, i.e. metals or aluminum-based metal alloys can, for example, be used here which can either be directly soldered or can be made solderable by means of a corresponding coating, for example a NiSn coating.

### SUMMARY OF THE INVENTION

According to the invention, it is proposed to use an aluminum-copper composite in order to improve the thermal shock resistance of the contact pins to be soldered. Said aluminum-copper composite relates, for example, to an extruded aluminum profile which comprises a Cu portion and an Al portion in a common plane. The Cu portion and the Al portion can on the one hand lie in a common plane that runs horizontally. Said portions can however also be disposed in planes which are different from one another and extend horizontally. Both embodiment options of the extruded aluminum profile have in common that the Cu portion and the Al portion are connected to one another within a transition region, for example by an arrow-shaped end of one of the two portions protruding into a complementarily configured receptacle of the respective other of the two portions. The portions are joined to one another in a materially bonded manner within the transition region. In accordance with the solution proposed according to the invention, the contact element is manufactured from an Al/Cu material composite, wherein the Cu portion of which forms the plug side of the contact element and the Al portion of the Al/Cu material composite forms the solder side of said contact element.

The contact elements, whether said elements comprise a common plane in relation to solder side and plug side or whether the solder side and the plug side are designed so as to lie in different planes, are preferably punched out of the Al/Cu material composite. This offers the advantage of a very efficient large-scale manufacturability and a very high utilization of the Al/Cu material composite with regard to accruing residual material.

The contact element proposed according to the invention and punched out of the Al/Cu material composite has a plug-side geometry in the form of plug pins on the plug side. The plug pins form a material composite and can be connected to one another by individual webs. On the solder side, i.e. of the aluminum portion of the extruded aluminum profile, a solder-side geometry can be formed which, for example, can be configured in the form of a contact composite comprising individual contact wires. In so doing, the individual contact wires of the contact composite can have the same length or also lengths which in each case are different from one another.

In an advantageous manner, it is possible by means of the contact element proposed according to the invention that on the one hand the plug side of the contact element continues to be formed from a copper alloy; whereas an aluminum alloy is used on the solder side, said alloy having less rigidity with regard to the modulus of elasticity and a greater coefficient of thermal expansion. In the case of a thermally induced stress on the plug pin in the form of bending, twisting or tensile load, a portion of this mechanical stress, which can result in damage to the contact element, is absorbed by the more flexible aluminum material which is located on the circuit board side or on the carrier substrate. The contact element, taken as a whole, has a longer damage-free time and thus a longer service life.

If the contact element is made from an Al/Cu material composite, the Cu portion of which and the Al portion of which run in a common horizontal plane, a particularly efficient production in terms of manufacturing technology is possible for the large-scale production of the contact element proposed according to the invention. On the other hand, the prefabrication of the extruded material of the Al/Cu material composite also offers the possibility of accommodating different installation geometries of the contact element. Thus, the Cu portion and the Al portion can, for example, not only be designed to lie in a common plane; but in fact the option exists for the two said portions to also run in horizontal planes that are different from one another.

The two portions, i.e. the Cu portion and the Al portion, of the Al/Cu material composite of the extruded profile are connected to one another within a transition region, i.e. merge into one another. The transition region is provided with regard to the mechanical stability thereof in such a way that said region can withstand the mechanical stresses which impact the extruded profile during a punching process or the like.

### BRIEF DESCRIPTION OF THE DRAWINGS

The invention is described below in more detail with the aid of the drawings.

In the drawings:

FIG. 1 shows a Al/Cu material composite, the Cu portion of which and the Al portion of which lie in a common horizontal plane,

FIG. 2 shows a contact element having a plug-side and a solder-side geometry;

FIG. 3 shows a cross section through a Al/Cu material composite in which the Al portion and the Cu portion lie in horizontal planes that are different from one another.

### DETAILED DESCRIPTION

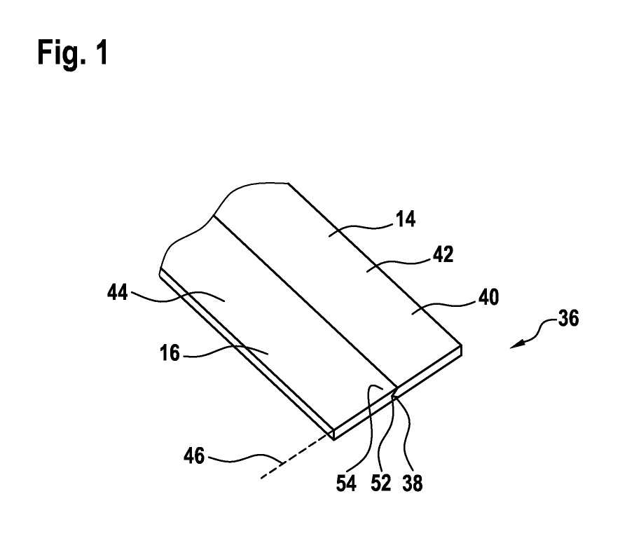

An Al/Cu material composite can be seen in the depiction pursuant to FIG. 1 in a perspective top view, the Cu portion of which and the Al portion of which run in a common horizontal plane.

From the depiction pursuant to FIG. 1, it follows that an extruded profile 40 of an Al/Cu material composite 36 comprises a Cu portion 42 and an Al portion. Said portions 42 or 44 constitute aluminum alloys or Cu alloys which are connected to one another within a transition region 38. From the depiction pursuant to FIG. 1, it can be seen that an arrow-shaped end 42 of the Cu portion 42 protrudes into a complementarily configured receptacle 54 of the Al portion 44 in a horizontal plane in the transition region 38 between the Cu portion 42 and the Al portion 44. Within the transition region 38, the two portions, i.e. the Cu portion 42 and the Al-portion 44, are connected to one another in a materially bonded and force-fit manner; thus enabling a Al/Cu material composite 36 consisting of said sections 42, 44 to result which can even withstand mechanical stresses which impact the Al/Cu material composite 35 during a punching process of the contact element 10 proposed according to the invention.

It is shown in the depiction pursuant to FIG. 1 that the Cu portion 42 constitutes a plug side 14 of a contact element 10 while a solder side 16 of the contact element 10 is formed by the Al portion 44 of the Al/Cu material composite 36. Instead of the geometry depicted in FIG. 1 with regard to the transition region 30 comprising an arrow-shaped end 52 and a complementarily configured receptacle 54, other transition geometries can also be formed in the transition region 38 between the Cu portion 42 and the Al portion 44 of the Al/Cu material composite 36.

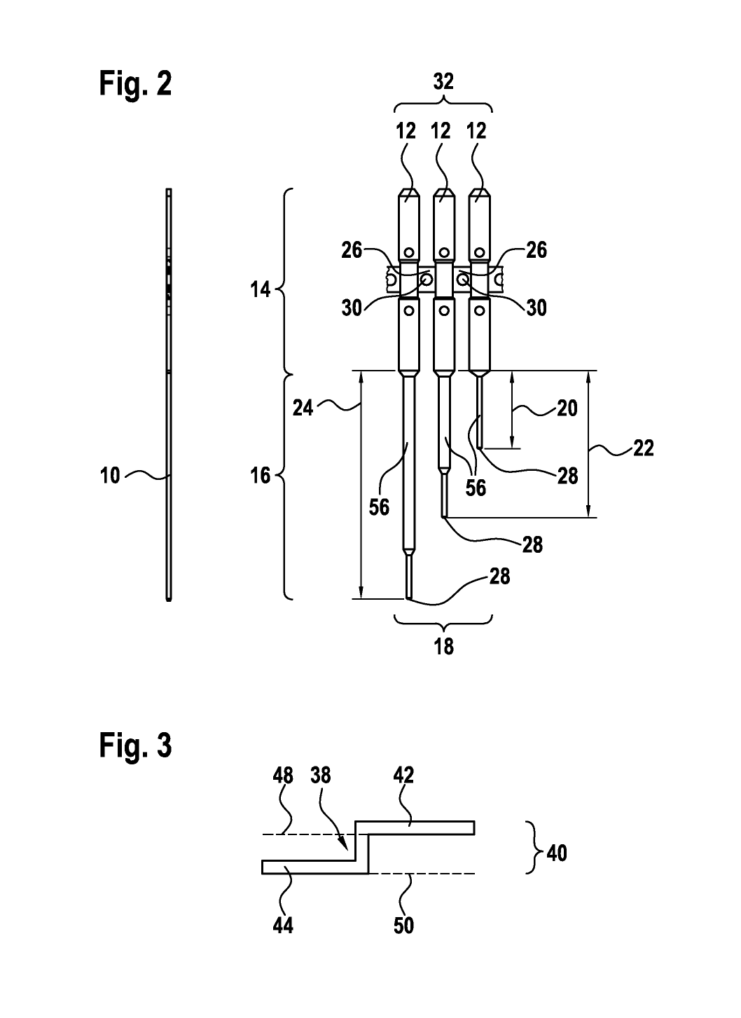

A top view of a contact element proposed according to the invention from the Al/Cu material composite pursuant to FIG. 1 can be seen in the depiction pursuant to FIG. 2.

It follows from the top view pursuant to FIG. 2 that the contact element 10 comprises a row of plug pins 12 on the plug side 14 thereof that is formed by the Cu portion 42. The individual plug pins 12 on the plug side 14 are connected to one another by means of webs 26 and form a plug-side geometry 32. The plug-side geometry 32 is provided by the Cu portion 42 of the extruded profile 40 that is designed as an Al/Cu material composite and was previously mentioned in connection with FIG. 1. The webs 26 are provided with individual openings 30.

Pursuant to the top view in FIG. 2, the contact element 10 furthermore comprises the solder side 16, which is provided by the Al portion 44 of the Al/Cu material composite 36. It can be seen from the depiction pursuant to FIG. 2 that contact elements 10 have individual contact wires 56 in this region, i.e. on the solder side 16. The individual contact wires 56 comprise a soldering tip 20, wherein the individual contact wires 56 can be designed having different lengths. It can be seen in the depiction pursuant to FIG. 2 that the individual contact wires 56 in said depiction pursuant to FIG. 2 can have either a first length, a second length 22 or a third length 24.

Besides the constitution of the contact wires 56 in the different lengths 20, 22, and 24 as depicted in FIG. 2, the contact wires 56 could also have a uniform length that is independent of the first length 20, the second length 22 and the third length 24.

The contact wires 56 form a contact composite 18 and constitute a solder-side geometry 34 of the contact element 10.

Taking recourse to FIG. 1, the contact wires 56 of the solder-side geometry 34 are provided by the Al portion 44 of the Al/Cu material composite 36, whereas the plug pins 12 according to the plug-side geometry 32 are constituted by the individual plug pins 12—embodied here in a uniform length.

It can be seen in the depiction pursuant to FIG. 2 that the soldering tips 28 of the contact wires 56, constituting the solder-side geometry, consist of aluminum. The contact wires 56 of the contact composite 18 are namely configured in the Al portion 44 of the Al/Cu material composite 36 and have less rigidity with regard to the modulus of elasticity and furthermore a greater coefficient of thermal expansion. Within the plug side 14, the plug pins are still made from a Cu alloy which forms the Cu portion of the Al/Cu material composite 36. When thermally induced stresses on the plug pins 12 occur in the region of the plug side 14 of the contact element 10, for example as a result of bending, twisting or tensile load and the like, a portion of the harmful stresses are absorbed by aluminum material of the solder side 16 which has substantially more flexible properties and is formed by the Al portion 44 of the Al/Cu material composite. As a result, a longer damage-free time and consequently a longer service life of the contact element 10 proposed according to the invention is to be expected.

A possible embodiment variant of the Al/Cu material composite 36 pursuant to the depiction in FIG. 1 can be seen in the depiction pursuant to FIG. 2. On the plug side 14 and the solder side 16 of the contact element 10, other geometries can, of course, also be punched or produced in another manner from the Al/Cu material composite 36 depicted in FIG. 1, said geometries deviating from the geometry of the contact element 10 according to the depiction in FIG. 2.

FIG. 3 shows a further possible embodiment variant of the Al/Cu material composite pursuant to the depiction in FIG. 1.

As an alternative to the depiction pursuant to FIG. 1 in which the Al/Cu material composite 36 runs in a common horizontal plane 46, the Cu portion 42 of the Al/Cu material composite 36 as well as the Al portion 44 of the Al/Cu material composite 36 can also have the geometry depicted in FIG. 3. This geometry differs from the geometry of the Al/Cu material composite 36 depicted in FIG. 1, which runs in a common horizontal plane 46, by virtue of the fact that the Cu portion 42 extends in a first horizontal plane 48 and the Al portion 44 extends in a second horizontal plane 50 that is different from said first horizontal plane. The first horizontal plane 48 and the second horizontal plane 50 of the embodiment variant of the extruded profile 40 according to the depiction in FIG. 3 show that the Cu portion 42 and the Al portion 44 of the extruded profile 40 can run in different horizontal planes 48 or 50 that are oriented offset to one another. This is dependent on the semi-finished product, i.e. on the extruded profile 40, in which the contact elements 10 proposed according to the invention are punched out or can otherwise be generated.

For the sake of completeness, it should be mentioned that, according to the embodiment variant of the extruded profile 40 pursuant to the depiction in FIG. 3, the transition region 38 between the Cu portion 42 and the Al-portion lies in the crank plane, i.e. in a vertical plane, in which a transition from the first horizontal plane 48 into the second horizontal plane 50 of the extruded profile 40 of the Al/Cu material composite 36 is present.

1. A contact element (10) with a plug side (14) and a solder side (16) configured to be contacted with a circuit board or a carrier substrate, characterized in that the contact element (10) is produced from an Al/Cu material composite (36), a Cu portion (42) of which forms the plug side (14) and an Al portion (44) of which forms the solder side (16) of the contact element (10).

2. The contact element according to claim 1, characterized in that the Cu portion (42) and the Al portion (44) lie in a common, horizontally extending plane (46).

3. The contact element according to claim 1, characterized in that the Cu portion (42) and the Al portion (44) run in horizontal planes (48, 50) that are different from one another.

4. The contact element according to claim 1, characterized that a transition region (38) runs between the Cu portion (42) and the Al portion (44).

5. The contact element according to claim 4, characterized in that, in the transition region (38), an arrow-shaped end (52) of the Cu portion (42) passes into a complementarily configured receptacle (54) of the Al portion (44).

6. The contact element according to claim 1, characterized in that said contact element is punched out of the Al/Cu material composite (36).

7. The contact element according to claim 1, characterized in that the contact element (10) comprises a plug-side geometry (32) in the form of plug pins (12) on the plug side (14) thereof.

8. The contact element according to claim 1, characterized in that the contact element, on the solder side (16) thereof, has a solder-side geometry (34) in the form of a contact composite (18) of individual contact wires (56).

9. The contact element according to claim 8, characterized in that the contact wires (56) on the solder side (16) have different lengths (20, 22, 24).

10. (canceled)
